(19) United States
(12) Patent Application Publication
(10) Pub. No.: US 2026/0072278 A1
(43) Pub. Date: Mar. 12, 2026

(54) VIRTUAL IMAGE DISPLAY DEVICE AND OPTICAL UNIT

(71) Applicant: SEIKO EPSON CORPORATION, Tokyo (JP)

(72) Inventors: Takashi TAKEDA, SUWA-SHI (JP); Yuiga HAMADE, MATSUMOTO-SHI (JP)

(73) Assignee: SEIKO EPSON CORPORATION, Tokyo (JP)

(21) Appl. No.: 19/321,322

(22) Filed: Sep. 8, 2025

(30) Foreign Application Priority Data
Sep. 11, 2024 (JP) 2024-157328

(51) Int. Cl. G02B 27/01; G02F 1/13357; G02F 1/13363

(52) U.S. Cl. CPC G02B 27/0172; G02F 1/133603; G02F 1/133638; G02B 2027/0136; G02B 27/0176; G02B 2027/0178

(57) ABSTRACT

A virtual image display device includes a segmented OLED panel having a light emission region emitting a backlight and a first transparent region transmitting an external light, a display element having a pixel including a sub-pixel that faces the light emission region and transmits the backlight to emit a video light and a second transparent region that faces the first transparent region and transmits the external light, a patterned half-waveplate having a first polarization region that faces the sub-pixel and has a first polarization characteristic selectively functioning with respect to a linearly-polarized light in a polarization direction parallel to a first axis direction and a second polarization region that faces the second transparent region and has a polarization characteristic, and a polarization imaging optical system that faces the display element with the patterned half-waveplate in between, images the video light, and transmits the external light.

The present application is based on, and claims priority from JP Application Serial Number 2024-157328, filed Sep. 11, 2024, the disclosure of which is hereby incorporated by reference herein in its entirety.

### BACKGROUND

### 1. Technical Field

The present disclosure relates to a virtual image display device and an optical unit that enable observation of a virtual image, and particularly relates to a virtual image display device and the like using a transparent OLED panel and a transmissive liquid crystal panel, and an optical unit.

### 2. Related Art

As a see-through type virtual image display device that enables visual recognition of the outside world, there is known a device including a liquid crystal panel having an image display region and a transparent display region formed to surround the image display region, and a light guide plate that guides a backlight light incident on an end portion from a light source, in which the light guide plate includes a light emission region that irradiates the image display region of the liquid crystal panel with the backlight light and a light transmission region that transmits ambient light (WO 2016/056298). The virtual image display device is configured such that an ambient light reaches an observer from the light transmission region of the light guide plate and the transparent display region of the liquid crystal panel, and the ambient light passes through the light emission region of the light guide plate and the image display region of the liquid crystal panel and reaches the observer during a period in which the image display region is not irradiated with the backlight light. According to the configuration, see-through display in which a video light and an ambient light are superimposed is realized.

WO 2016/056298 is an example of the related art.

In the above-described device, processing such as formation of dots and application of a scattering material is performed on the light emission region of the light guide plate, and ambient light passing through the image display region of the liquid crystal panel passes through the processed light emission region, so that the see-through transmittance near the center of the field of view corresponding to the image display region is reduced. In order to realize see-through display with higher see-through transmittance near the center of the field of view, an optical system or the like with higher see-through transmittance is separately required, which leads to an increase in size.

### SUMMARY

A virtual image display device according to an aspect of the present disclosure includes a segmented OLED panel having a light emission region that is configured to emit a backlight and a first transparent region that is configured to transmit an external light, a display element having a pixel including a sub-pixel that faces the light emission region and is configured to transmit the backlight to emit a video light and a second transparent region that faces the first transparent region and is configured to transmit the external light, a patterned half-waveplate having a first polarization region that faces the sub-pixel and has a first polarization characteristic selectively functioning with respect to a linearly-polarized light in a polarization direction parallel to a first axis direction and a second polarization region that faces the second transparent region and has a polarization characteristic different from that of the first polarization region, and a polarization imaging optical system that faces the display element with the patterned half-waveplate in between, is configured to image the video light from the patterned half-waveplate, and is configured to transmit the external light from the patterned half-waveplate.

An optical unit according to an aspect of the present disclosure includes a segmented OLED panel having a light emission region that is configured to emit a backlight and a first transparent region that is configured to transmit an external light, a display element having a pixel including a sub-pixel that faces the light emission region and is configured to transmit the backlight to emit a video light and a second transparent region that faces the first transparent region and is configured to transmit the external light, a patterned half-waveplate having a first polarization region that faces the sub-pixel and has a first polarization characteristic selectively functioning with respect to a linearly-polarized light in a polarization direction parallel to a first axis direction and a second polarization region that faces the second transparent region and has a polarization characteristic different from that of the first polarization region, and a polarization imaging optical system that faces the display element with the patterned half-waveplate in between, is configured to image the video light from the patterned half-waveplate, and is configured to transmit the external light from the patterned half-waveplate.

### BRIEF DESCRIPTION OF THE DRAWINGS

FIG. 1 is an external front view illustrating a mounted state of a virtual image display device according to a first embodiment.

FIG. 2 is a conceptual perspective view illustrating a structure of a display optical system.

FIG. 3 is a perspective view illustrating a positional relationship among a light source member, a transmissive liquid crystal panel, and a patterned half-waveplate.

FIG. 4 is a side sectional view illustrating a display unit.

FIG. 5 illustrates a state of lights passing through the display unit.

FIG. 6 is a side sectional view showing an optical unit of the display optical system.

FIG. 7 is a conceptual perspective view illustrating a function of a polarization liquid crystal lens.

FIG. 8 is a side sectional view illustrating an example of a configuration of the light source member.

FIG. 9 is a side sectional view illustrating an example of the configuration of the light source member.

FIG. 10 is a perspective view illustrating a positional relationship among the light source member, the transmissive liquid crystal panel, and the patterned half-waveplate.

FIG. 11 is a perspective view illustrating a positional relationship among the light source member, the transmissive liquid crystal panel, and the patterned half-waveplate.

FIG. 12 is a perspective view illustrating a positional relationship among the light source member, the transmissive liquid crystal panel, and the patterned half-waveplate.

FIG. 13 is a perspective view illustrating a positional relationship among the light source member, the transmissive liquid crystal panel, and the patterned half-waveplate.

### DESCRIPTION OF EMBODIMENTS

### First Embodiment

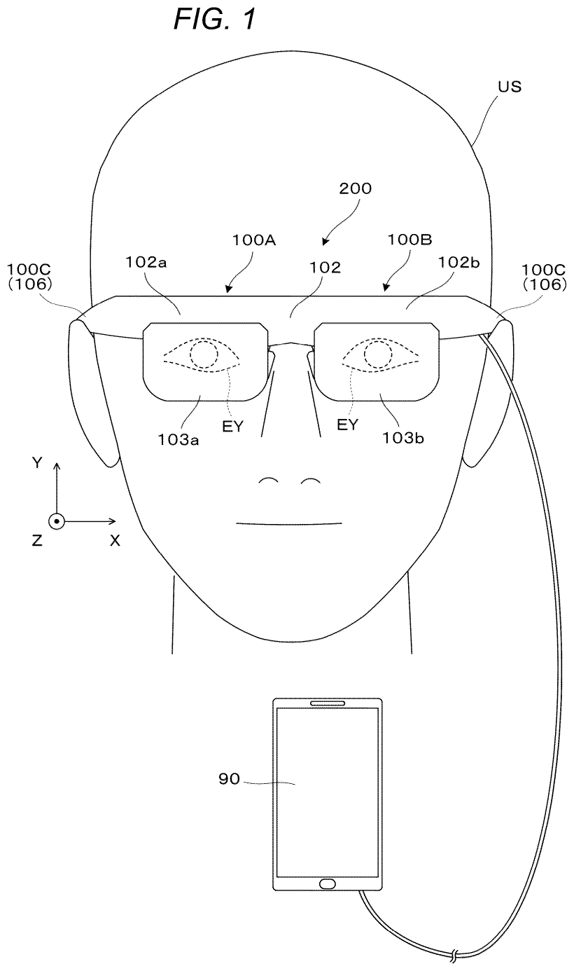

Hereinafter, a virtual image display device according to a first embodiment of the present disclosure will be described with reference to FIGS. 1 to 9.

FIG. 1 is a front view illustrating a mounted state of a head mounted display, that is, a head mounted display device 200. The head mounted display device (hereinafter also referred to as HMD) 200 causes an observer or a wearer US wearing the device to recognize a video as a virtual image. In FIG. 1 and the like, X, Y, and Z are orthogonal coordinate systems, a +X direction corresponds to a lateral direction in which both eyes EY of the observer or the wearer US wearing the HMD 200 are arranged, a +Y direction corresponds to an upward direction orthogonal to the lateral direction in which both eyes EY are arranged with respect to the wearer US, and a +Z direction corresponds to a forward direction or a frontward direction with respect to the wearer US. The +Y directions are parallel to the vertical axis or the vertical direction.

The HMD 200 includes a first virtual image display device 100A for the right eye, a second virtual image display device 100B for the left eye, a pair of temples 100C that support the virtual image display devices 100A and 100B, and a user terminal 90 that is an information terminal. The first virtual image display device 100A includes a first display drive unit 102a disposed in an upper portion and a first display optical system 103a that covers the front of the eye. The second virtual image display device 100B includes a second display drive unit 102b disposed in an upper portion and a second display optical system 103b that covers the front of the eye. The HMD 200 in which the first virtual image display device 100A and the second virtual image display device 100B are combined is also a virtual image display device in a broad sense. The pair of temples 100C are attachment members or support devices 106 mounted on the head of the wearer US, and support the upper end sides of the pair of display optical systems 103a and 103b via the display drive units 102a and 102b integrated in appearance. A combination of the pair of display drive units 102a and 102b is referred to as a drive device 102.

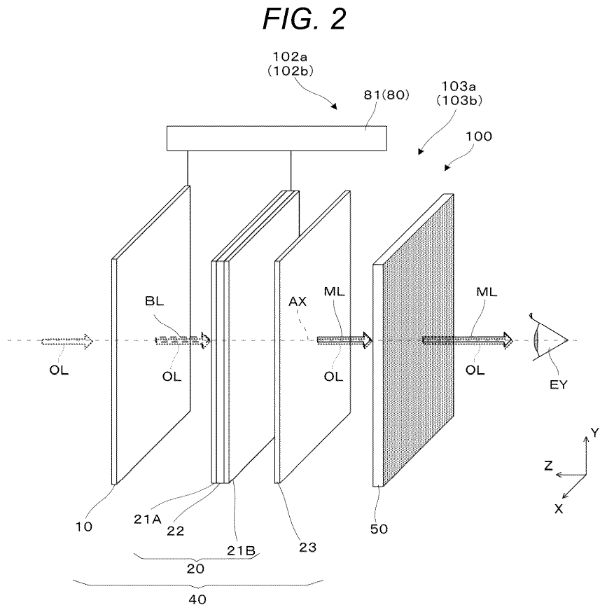

FIG. 2 is a conceptual perspective view illustrating a structure of the first display optical system 103a. The first display optical system 103a includes a plate-shaped display unit 40 that forms a two-dimensional image, emits a video light ML corresponding thereto, and transmits an external light OL, and a plate-shaped polarization imaging optical system 50 that functions as a lens for the video light ML emitted from the display unit 40 and having a first linearly-polarized light to form a virtual image, and has a polarization function of transmitting the external light OL having a second linearly-polarized light. In FIG. 2, for the configuration of the first display optical system 103a to be understood more readily, the distances between the component elements are partially enlarged.

The display unit 40 includes a light source member 10 that generates a white light, a display element 20 that forms and emits the video light ML, and a patterned half-waveplate 23. The light source member 10 emits the white light as a backlight BL. The light source member 10 may include a plurality of light sources that respectively generate lights of a plurality of colors selected so as to form a white light when superimposed. As an example, the light source member 10 may include a first light source that emits a backlight of a first color, a second light source that emits a backlight of a second color, and a third light source that emits a backlight of a third color. The display unit 40 is driven by a drive circuit 81 of a control device 80 incorporated in the first display drive unit 102a or the drive device 102 to operate. The display element 20 of the display unit 40 is disposed close to the eye EY with the polarization imaging optical system 50 in between, and enables observation of a virtual image by the video light ML and see-through viewing of the outside world. In the first display optical system 103a, the distance between the eye EY and the polarization imaging optical system 50 in a direction of an optical axis AX is, for example, about 10 mm to 20 mm. The distance between a transmissive liquid crystal panel 22 of the display unit 40 and the polarization imaging optical system 50 in the optical axis AX direction is, for example, about 5 mm to 25 mm.

The display element 20 is a plate-shaped member extending along the XY plane perpendicular to the optical axis AX, and includes a first polarizer 21A, the transmissive liquid crystal panel 22, and a second polarizer 21B in this order from the outside. The display element 20 has a structure in which the polarizers 21A and 21B and the transmissive liquid crystal panel 22 are stacked and integrated by a frame (not shown). Here, the first polarizer 21A and the transmissive liquid crystal panel 22 are disposed close to each other at a predetermined distance or less. The transmissive liquid crystal panel 22 and the second polarizer 21B are disposed close to each other at a predetermined distance or less. The transmissive liquid crystal panel 22 is an imager that simultaneously forms a first video light of a first color component, a second video light of a second color component, and a third video light of a third color component forming the video light ML. The transmissive liquid crystal panel 22 includes a plurality of pixels arranged in a matrix along the XY plane. Each of the plurality of pixels includes a first sub-pixel, a second sub-pixel, and a third sub-pixel that respectively form the first video light, the second video light, and the third video light forming the video light ML, and a transparent region that transmits the external light OL.

The patterned half-waveplate 23 includes at least two types of polarization regions having different polarization characteristics, and emits the video light ML transmitted through a first polarization region in a first polarization state, and emits the external light OL transmitted through the second polarization region in a second polarization state. In the patterned half-waveplate 23, the first polarization region is disposed to face the first sub-pixel, the second sub-pixel, and the third sub-pixel contained in each of the plurality of pixels provided in the transmissive liquid crystal panel 22. In the patterned half-waveplate 23, the second polarization region is disposed to face the transparent region contained in each of the plurality of pixels provided in the transmissive liquid crystal panel 22. As an example, the first polarization region has a first polarization characteristic that selectively functions with respect to a linearly-polarized light in a polarization direction parallel to a first axis direction contained in the XY plane, and the video light ML passing through the first polarization region becomes a linearly-polarized light in a first polarization direction. The second polarization region has a polarization characteristic different from that of the first polarization region, and the external light OL passing through the second polarization region becomes a linearly-polarized light in a second polarization direction orthogonal to the first polarization direction. The second polarization region may have a second polarization characteristic that selectively functions with respect to a linearly-polarized light contained in the XY plane and orthogonal to the first axis direction.

The polarization imaging optical system 50 is disposed at the face side, that is, the −Z side with respect to the display unit 40 or the display element 20 and covers the front of the eye. The polarization imaging optical system 50 is a plate-shaped member extending along the XY plane. The polarization imaging optical system 50 is an optical element that performs a different action functioning as a lens or transmitting an incident light depending on the polarization state of the incident light. More specifically, the polarization imaging optical system 50 functions as a lens for the video light ML having the first polarization state emitted from the display element 20. That is, the polarization imaging optical system 50 comprehensively images the video lights ML emitted from the plurality of pixels provided in the transmissive liquid crystal panel 22, and enables observation of the image formed on the transmissive liquid crystal panel 22 as a virtual image. On the other hand, the polarization imaging optical system 50 functions as a parallel plate for the external light OL passing through the display element 20 and having the second polarization state. That is, the external light OL is transmitted through the display element 20 so as to travel straight, and is thereby observed as a direct-view image. Here, the virtual image formed by the video light ML by the polarization imaging optical system 50 and the direct-view image formed by the external light OL transmitted through the polarization imaging optical system 50 are simultaneously observed in the eye EY.

The second display optical system 103b is optically the same as the first display optical system 103a or is obtained by horizontally flipping the first display optical system 103a, and the detailed description thereof will be omitted.

In the first virtual image display device 100A, the optical device excluding the control device 80 is referred to as an optical unit 100. In the second virtual image display device 100B, an optical device excluding the control device 80 is referred to as an optical unit 100.

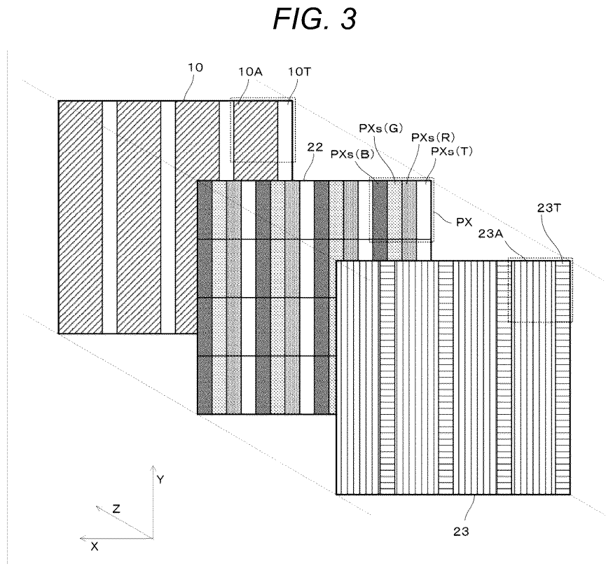

FIG. 3 is a perspective view illustrating a positional relationship among the light source member 10, the transmissive liquid crystal panel 22, and the patterned half-waveplate 23. The light source member 10 includes a segmented OLED (organic light emitting diode) panel including a light emission region 10A that emits the backlight BL and a transparent region 10T that transmits the external light OL. The light source member 10 may include a plurality of the light emission regions 10A and a plurality of the transparent regions 10T. The light emission regions 10A and the transparent regions 10T are alternately arranged one by one in a first arrangement direction contained in the XY plane. Each light emission region 10A and each transparent region 10T extend in a second arrangement direction contained in the XY plane and orthogonal to the first arrangement direction. As shown in the example in FIG. 3, each light emission region 10A and each transparent region 10T may extend in band shapes over the entire light source member 10 in the second arrangement direction, or the light emission regions 10A and the transparent regions 10T may be alternately arranged one by one in the first arrangement direction. In the example in FIG. 3, the first arrangement direction is parallel to the X direction, and the second arrangement direction is parallel to the Y direction, but the present embodiment is not limited to this example.

The transmissive liquid crystal panel 22 includes a plurality of pixels PX, and each pixel PX includes a first-color sub-pixel PXs (R), a second-color sub-pixel PXs (G), a third-color sub-pixel PXs (B), and a transparent region PXs (T) that transmits the external light OL. In each pixel PX, the first-color sub-pixel PXs (R), the second-color sub-pixel PXs (G), the third-color sub-pixel PXs (B), and the transparent region PXs (T) are arranged adjacent to each other in the first arrangement direction. The order in which the first-color sub-pixel PXs (R), the second-color sub-pixel PXs (G), the third-color sub-pixel PXs (B), and the transparent region PXs (T) are arranged in the first arrangement direction is not limited. In each pixel PX, the first-color sub-pixel PXs (R), the second-color sub-pixel PXs (G), the third-color sub-pixel PXs (B), and the transparent region PXs (T) that transmits the external light OL extend in the second arrangement direction. The transparent region PXs (T) may extend in a band shape across the plurality of pixels PX adjacent in the second arrangement direction, or may be integrated. In the configuration example in FIG. 3, although the sub-pixels PXs (R), PXs (G), and PXs (B) and the transparent region PXs (T) provided in each pixel PX have the same width in the first arrangement direction, this is merely an example, but the present embodiment is not limited thereto. As an example, the ratio of the width of the transparent region PXs (T) in the first arrangement direction to the width of the pixel PX in the first arrangement direction may be optionally changed. The ratio of the width of each of the sub-pixels PXs (R), PXs (G), and PXs (B) in the first arrangement direction to the width of the pixel PX in the first arrangement direction may be optionally changed. However, in any case, the sub-pixels PXs (R), PXs (G), and PXs (B) are arranged to face the transparent region PXs (T) so that the backlight BL from the light emission region 10A of the light source member 10 is not incident on the transparent region PXs (T), but incident on the sub-pixels PXs (R), PXs (G), and PXs (B). Further, the transparent region PXs (T) is disposed to face the transparent region 10T so that the external light OL from the transparent region 10T of the light source member 10 is not incident on the sub-pixels PXs (R), PXs (G), and PXs (B), but incident on the transparent region PXs (T).

The patterned half-waveplate 23 includes a first polarization region 23A and a second polarization region 23T having different polarization characteristics. The patterned half-waveplate 23 may include a plurality of the first polarization regions 23A and a plurality of the second polarization regions 23T. The first polarization regions 23A and the second polarization regions 23T are alternately arranged adjacent to each other one by one in the first arrangement direction contained in the XY plane. Each of the first polarization regions 23A and each of the second polarization regions 23T extend in the second arrangement direction. Each of the first polarization regions 23A and each of the second polarization regions 23T may extend in band shapes over the entire patterned half-waveplate 23 in the second arrangement direction. The pattern indicating the positional relationship between the first polarization regions 23A and the second polarization regions 23T in the patterned half-waveplate 23 is not limited to the regular form illustrated in the example in FIG. 3. However, in any case, the first polarization region 23A is disposed to face the sub-pixels PXs (R), PXs (G), and PXs (B) so that the first video light, the second video light, and the third video light emitted by the sub-pixels PXs (R), PXs (G), and PXs (B) are not incident on the second polarization region 23T, but incident on the first polarization region 23A. Further, the second polarization region 23T is disposed to face the transparent region PXs (T) so that the external light OL transmitted through the transparent region PXs (T) is not incident on the first polarization region 23A, but incident on the second polarization region 23T.

The light emission region 10A of the light source member 10 and the sub-pixels PXs (R), PXs (G), and PXs (B) of the transmissive liquid crystal panel 22 are arranged to face each other. Further, the sub-pixels PXs (R), PXs (G), and PXs (B) of the transmissive liquid crystal panel 22 and the first polarization region 23A of the patterned half-waveplate 23 are arranged to face each other. The sub-pixels PXs (R), PXs (G), and PXs (B) of the transmissive liquid crystal panel 22 are irradiated with the backlight BL emitted from the light emission region 10A of the light source member 10 to emit the video lights ML. The video lights ML are transmitted through the first polarization region 23A of the patterned half-waveplate 23 and come into the first polarization state. As an example, the video light ML in the first polarization state may have a linearly-polarized light whose polarization direction is parallel to a predetermined first polarization direction contained in the XY plane.

The transparent region 10T of the light source member 10 and the transparent region PXs (T) of the transmissive liquid crystal panel 22 are disposed to face each other. The transparent region PXs (T) of the transmissive liquid crystal panel 22 and the second polarization region 23T of the patterned half-waveplate 23 are disposed to face each other. The external light OL is transmitted through the transparent region 10T of the light source member 10 and the transparent region PXs (T) of the transmissive liquid crystal panel 22, then transmitted through the second polarization region 23T of the patterned half-waveplate 23, and comes into the second polarization state. The external light OL in the second polarization state may have a linearly-polarized light whose polarization direction is contained in the XY plane and which is parallel to the second polarization direction orthogonal to the first polarization direction.

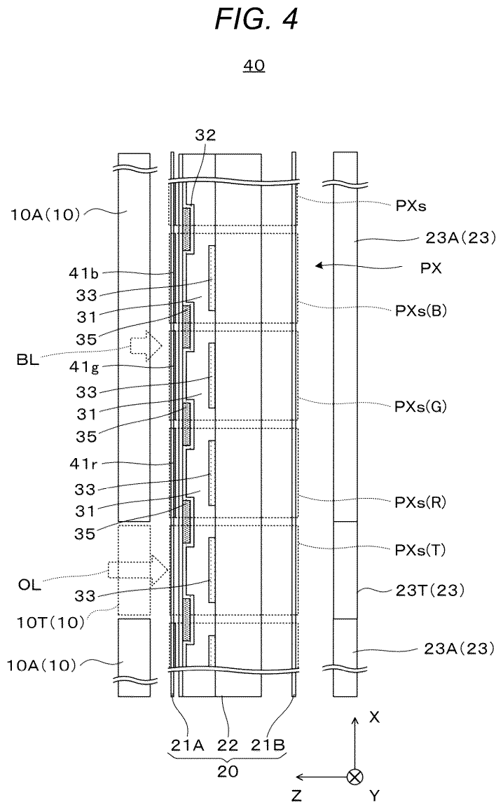

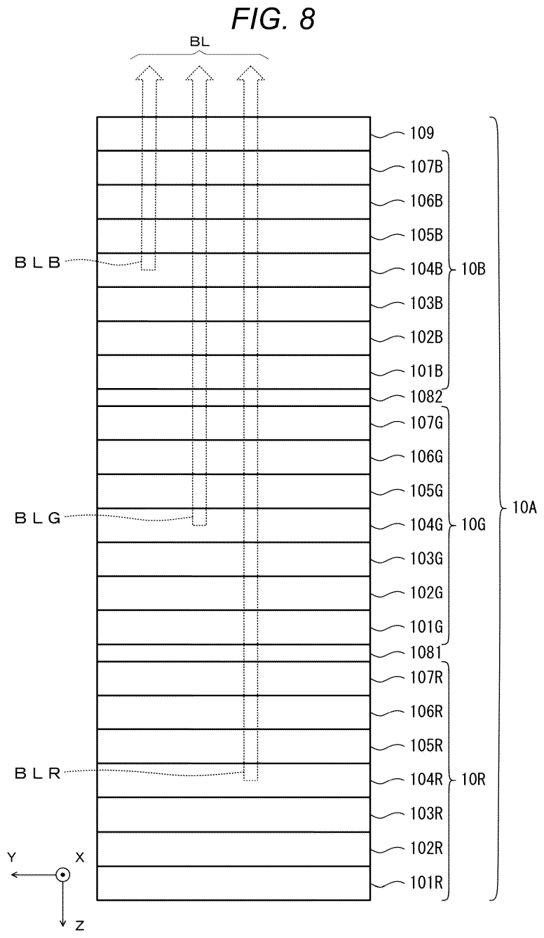

FIG. 4 is a conceptual enlarged cross-sectional view illustrating a structure of the display unit 40. Referring to FIG. 4, the light source member 10 simultaneously generates backlights BLR, BLG, and BLB of three colors (see FIG. 8) to supply a white light as the backlight BL to the transmissive liquid crystal panel 22 of the display element 20.

The display element 20 is disposed at the face side, that is, the −Z side to face the light source member 10 and the first polarizer 21A. The display element 20 includes the transmissive liquid crystal panel 22 and the pair of polarizers 21A and 21B sandwiching the transmissive liquid crystal panel 22. In this case, the display element 20 is, for example, a modulation element of IPS (in-plane switching)-type liquid crystal and operates in units of pixels PX. Each of the pixels PX includes the first-color sub-pixel PXs (R), the second-color sub-pixel PXs (G), a third-color sub-pixel PXs (B), and the transparent region PXs (T). The first-color sub-pixel PXs (R) includes a first-color color filter 41r, the second-color sub-pixel PXs (G) includes a second-color color filter 41g, and the third-color sub-pixel PXs (B) includes a third-color color filter 41b. The transparent region PXs (T) does not have a color filter and is colorless. The display element 20 does not rotate the polarization direction of the incident light when an electric field is not applied, and rotates the polarization direction of the incident light when the electric field is applied. In this case, the pair of polarizers 21A and 21B are absorption-type polarization elements, and are disposed such that the polarization directions thereof intersect each other, more specifically, the polarization directions thereof are orthogonal to each other. The display element 20 can switch between ON and OFF in units of pixels PX according to the drive signal from the drive circuit 81, and can partially pass the incident light at an optional gray level between ON and OFF. Therefore, the transmissive liquid crystal panel 22 includes not only liquid crystal layers 31, a common electrode 32, pixel electrodes 33, and black matrices 35 but also scanning lines, signal lines, switch elements, and the like, which are not illustrated. However, regarding the transparent region PXs (T), the pixel electrode 33 can be omitted, and the transmittance of the transparent region PXs (T) for the external light OL can be improved by omitting the pixel electrode 33. The transmissive liquid crystal panel 22 is preferably produced as an HTPS (high-temperature poly-silicon) panel for higher definition.

The first-color color filter 41r selectively transmits a first-color light in the backlight BL. Similarly, the second-color color filter 41g selectively transmits a second-color light of the backlight BL. The third-color color filter 41b selectively transmits a third-color light of the backlight BL. As an example, the first color is red (r: red) having a wavelength in a range of about 620 nm (nanometers) to about 750 nm, the second color is green (g: green) having a wavelength in a range of about 495 nm to about 570 nm, and the third color is blue (b: blue) having a wavelength in a range of about 450 nm to about 495 nm. Hereinafter, in any light, a portion whose wavelength is within the range of the first color is referred to as a first-color wavelength component of the light, a portion whose wavelength is within the range of the second color is referred to as a second-color wavelength component of the light, and a portion whose wavelength is within the range of the third color is referred to as a third-color wavelength component of the light.

The first-color sub-pixel PXS (R) applies intensity controlled by the control device 80 to the first-color light as the first-color wavelength component contained in the backlight BL, and emits the light as the first video light as the first-color wavelength component forming the video light ML, thereby displaying a first video representing an intensity distribution of the first-color wavelength component in the videos represented by the video light ML. Similarly, the second-color sub-pixel PXs (G) applies intensity controlled by the control device 80 to the second-color light as the second-color wavelength component contained in the backlight BL, and emits the light as the second video light as the second-color wavelength component forming the video light ML, thereby displaying a second video representing an intensity distribution of the second-color wavelength component in the videos represented by the video light ML. The third-color sub-pixel PXs (B) applies the intensity controlled by the control device 80 to the third-color light as the third-color wavelength component contained in the backlight BL, and emits the light as the third video light as the third-color wavelength component forming the video light ML, thereby displaying a third video representing an intensity distribution of the third-color wavelength component in the videos represented by the video light ML. Each pixel PX can represent various colors by combining the first video light emitted by the first-color sub-pixel PXs (R), the second video light emitted by the second-color sub-pixel PXs (G), and the third video light emitted by the third-color sub-pixel PXs (B).

The display element 20 or the transmissive liquid crystal panel 22 may rotate the polarization direction of the incident light when an electric field is not applied, and may not rotate the polarization direction of the incident light when an electric field is applied. In this case, the pair of polarizers 21A and 21B are disposed such that the polarization directions thereof are parallel to each other.

In the patterned half-waveplate 23, the first polarization region 23A has a principal axis in a first direction in the XY plane, and converts the polarization state of the video light ML (see FIG. 2) from a linearly-polarized light P1 into a linearly-polarized light P3. In the patterned half-waveplate 23, the second polarization region 23T has a principal axis in a second direction in the XY plane, and converts the polarization state of the external light OL from a linearly-polarized light P2 into a linearly-polarized light P4. The principal axes of the first polarization region 23A and the second polarization region 23T of the patterned half-waveplate 23 are set such that the polarization directions of the linearly-polarized lights P3 and P4 of the video light ML and the external light OL emitted from the patterned half-waveplate 23 to the eye EY are orthogonal to each other.

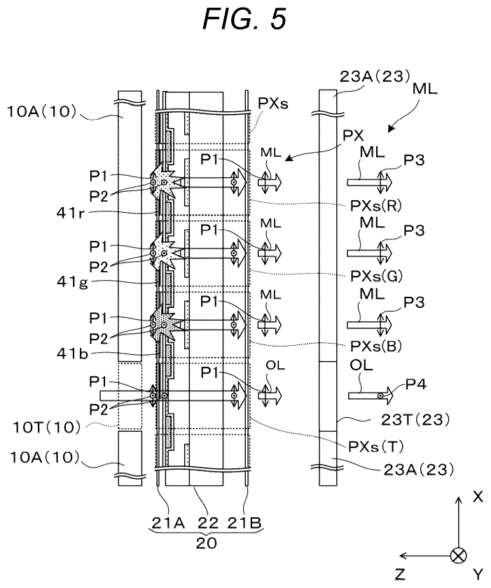

FIG. 5 illustrates a state of lights passing through the display unit 40. The light emission region 10A of the light source member 10 emits a light in response to a control signal from the control device 80 shown in FIG. 2, and the backlight BL is emitted toward the display element 20. The backlight BL illuminates the transmissive liquid crystal panel 22 as the second linearly-polarized light P2, which is a laterally polarized light or a horizontally polarized light, via the first polarizer 21A of the display element 20. That is, among the pixels PX forming the display element 20, the sub-pixels PXs (R), PXs (G), and PXs (B) facing the light emission region 10A of the light source member 10 are illuminated. The video light ML passing through the transmissive liquid crystal panel 22 is obtained by rotating the polarization plane of the backlight BL according to the drive signal, and only the first linearly-polarized light P1 which is a longitudinally polarized light or a vertically polarized light is emitted through the second polarizer 21B. The video lights ML emitted from the sub-pixels PXs (R), PXs (G), and PXs (B) contained in each pixel PX of the display element 20 are converted from the first linearly-polarized lights P1 into the third linearly-polarized lights P3 through the first polarization region 23A of the patterned half-waveplate 23. As an example, the third linearly-polarized light P3 is a linearly-polarized light whose polarization direction is parallel to the first direction contained in the XY plane.

The external light OL passes through the transparent region 10T of the light source member 10 and is incident on the display element 20. The transparent region PXs (T) provided in each pixel PX of the display element 20 is transparent for the external light OL, and the second linearly-polarized light P2 of the external light OL incident on the transparent region PXs (T) provided in each pixel PX of the display element 20 travels straight through the first polarizer 21A, the transparent region PXs (T), and the second polarizer 21B provided in the display element 20 and is converted into the first linearly-polarized light P1. The external light OL emitted from the display element 20 is converted from the first linearly-polarized light P1 into the fourth linearly-polarized light P4 through the patterned half-waveplate 23. As an example, the fourth linearly-polarized light P4 is a linearly-polarized light whose polarization direction is parallel to the second direction contained in the XY plane, and the second polarization direction of the fourth linearly-polarized light P4 is orthogonal to the first polarization direction of the third linearly-polarized light P3.

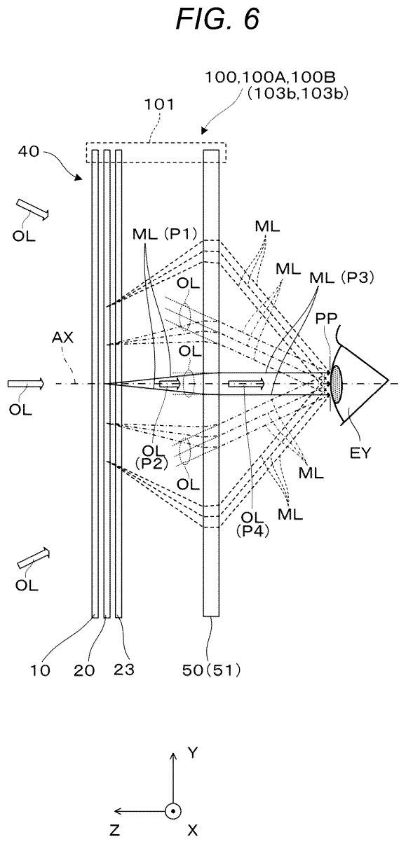

FIG. 6 is a side cross-sectional view illustrating the optical unit 100 of the display optical systems 103a and 103b. The optical unit 100 includes the display unit 40 that emits the video light ML and transmits the external light OL, the polarization imaging optical system 50 that functions as a positive lens or a collimator having positive power with respect to the video light ML and transmits the external light OL, and a support member 101 that relatively fixes these components.

In the polarization imaging optical system 50, a polarization liquid crystal lens 51 alone functions like a positive lens when a linearly-polarized light having a predetermined polarization direction is incident. When a linearly-polarized light having another polarization direction is incident, the polarization liquid crystal lens 51 transmits the linearly-polarized light.

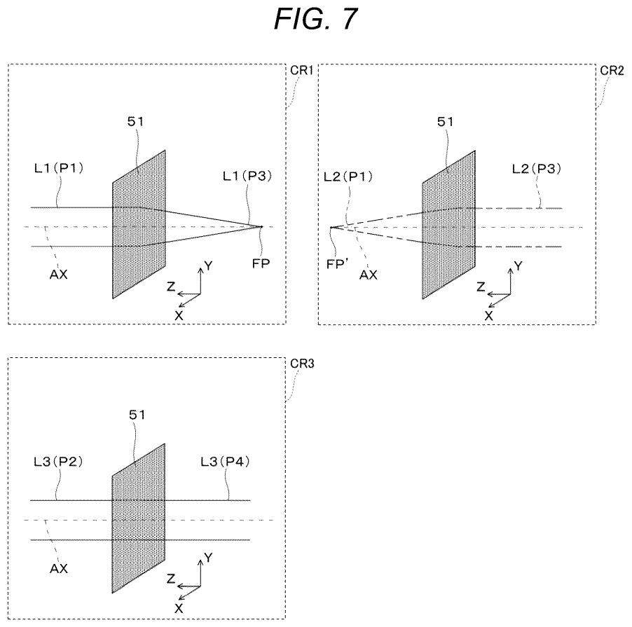

FIG. 7 is a conceptual perspective view illustrating the function of the polarization liquid crystal lens 51. In FIG. 7, a first area CR1 and a second area CR2 show an operation example of the polarization liquid crystal lens 51 when beams L1 and L2 of the first linearly-polarized light P1 in the first polarization direction are incident. In FIG. 7, a third area CR3 shows an operation example of the polarization liquid crystal lens 51 when a beam L3 of the second linearly-polarized light P2 in the second polarization direction is incident.

As illustrated in the first area CR1 in FIG. 7, the polarization liquid crystal lens 51 has a function of converting the first linearly-polarized light P1 into the third linearly-polarized light P3 and converging the third linearly-polarized light P3 to be focused on a focal point FP when the collimated first linearly-polarized light P1 such as the beam L1 indicated by a solid line is incident from the left side of the drawing. As illustrated in the second area CR2 in FIG. 7, the polarization liquid crystal lens 51 has a function of converting the first linearly-polarized light P1 into the third linearly-polarized light P3 and collimating the third linearly-polarized light P3 when the first linearly-polarized light P1 diverging from a focal point FP′ on the left side of the drawing such as the beam L2 indicated by a two-dot chain line is incident. That is, the polarization liquid crystal lens 51 changes the direction of the linearly-polarized light while functioning as a positive lens having a predetermined focal length with respect to the first linearly-polarized light P1. However, the polarization direction of the third linearly-polarized light P3 after the change may be the same as the polarization direction of the first linearly-polarized light P1 before the change.

As illustrated in the third area CR3 in FIG. 7, the polarization liquid crystal lens 51 has a function of converting the second linearly-polarized light P2 into the fourth linearly-polarized light P4 and emitting the fourth linearly-polarized light P4 remaining in the collimated state when the collimated second linearly-polarized light P2 such as the beam L3 indicated by a solid line is incident from the left side of the drawing. That is, the polarization liquid crystal lens 51 changes the direction of the linearly-polarized light of the external light OL while transmitting the second linearly-polarized light P2 without converging or diverging. However, the polarization direction of the fourth linearly-polarized light P4 after the change may be the same as the polarization direction of the second linearly-polarized light P2 before the change.

Although not illustrated, the polarization liquid crystal lens 51 is obtained by forming a thin film of a liquid crystal-containing material layer on a transparent substrate, and has a thin plate shape as a whole. The liquid crystal-containing material layer contains a predetermined liquid crystal material, and alignment axes of liquid crystal molecules are aligned so that an expected geometric phase is formed. As a method of manufacturing the polarization liquid crystal lens 51, for example, a liquid crystal-containing material film, which is a mixture of a liquid crystal material and an ultraviolet curable organic material layer, is applied onto a substrate, and the liquid crystal-containing material film is two-dimensionally scanned with a UV laser beam in a predetermined polarization state, thereby curing the organic material layer while adjusting the alignment axes of the liquid crystal molecules. Thus, the alignment axes of the liquid crystal molecules can be three-dimensionally controlled and fixed in the liquid crystal-containing material layer, and a liquid crystal compound layer in which the rotation angle of the alignment axis increases as the distance from the optical axis AX increases is obtained. The above-described polarization liquid crystal lens 51 itself is known as, for example, a polarization-dependent liquid crystal Fresnel lens (see, for example, Kohei Noda, et al., Applied Optics, Feb. 10, 2017, Vol. 56, No. 5:1302).

The focal length of the polarization liquid crystal lens 51 can be increased or decreased by the manufacturing method or the liquid crystal material. When the beams pass through the polarization liquid crystal lens 51, the loss of the linearly-polarized light beams L1, L2, and L3 is close to zero, and the polarization liquid crystal lens 51 exhibits almost 100% transmittance.

Returning to FIG. 6, in the polarization imaging optical system 50, the polarization liquid crystal lens 51 is the polarization liquid crystal lens 51 illustrated in FIG. 7, when the video light ML incident from the display unit 40 is the first linearly-polarized light P1, the polarization liquid crystal lens 51 functions as an optical element having positive power with respect to the video light ML, and changes the direction of the linearly-polarized light into the third linearly-polarized light P3 while reducing the divergence of the video light ML. When the external light OL incident from the display unit 40 is the second linearly-polarized light P2, the polarization liquid crystal lens 51 changes the direction of the linearly-polarized light of the external light OL into the fourth linearly-polarized light P4 while transmitting the external light OL without converging or diverging. However, the polarization direction of the third linearly-polarized light P3 after the change may be the same as the polarization direction of the first linearly-polarized light P1 before the change, and the polarization direction of the fourth linearly-polarized light P4 after the change may be the same as the polarization direction of the second linearly-polarized light P2 before the change.

As described above, the polarization liquid crystal lens 51 simultaneously exerts the different functions according to the polarization direction of the linearly-polarized light of the incident light, converges the video light ML, and transmits the external light OL without converging or diverging. That is, the virtual image display devices 100A and 100B or the display optical systems 103a and 103b that perform the above-described display enable see-through display in which the video light ML and the external light OL are simultaneously superimposed.

### Modification Example of Light Source Member

In the above-described embodiment, the configuration in which the light source member 10 includes the light emission region 10A that emits the white light as the backlight BL and the segmented OLED panel that transmits the external light OL is described. In this configuration, as shown in FIG. 8, the light emission region 10A may include a first light source 10R that emits a first-color backlight BLR, a second light source 10G that emits a second-color backlight BLG, and a third light source 10B that emits a third-color backlight BLB.

In the example in FIG. 8, the first light source 10R, a first adhesive layer 1081, the second light source 10G, a second adhesive layer 1082, the third light source 10B, and a cover member 109 provided in the light source member 10 are stacked in this order in the −Z direction in the orthogonal coordinate system. The first light source 10R includes a first transmissive OLED element that emits the first backlight BLR as the first-color light. A first transparent substrate 101R, a first transparent anode 102R, a first hole transport layer 103R, a first light-emitting layer 104R, a first electron transport layer 105R, a first transparent cathode 106R, and a first sealing layer 107R provided in the first transmissive OLED element are stacked in this order in the −Z direction in the orthogonal coordinate system.

When an appropriate voltage is applied between the first transparent anode 102R and the first transparent cathode 106R, the first transmissive OLED element emits the first-color light from the first light-emitting layer 104R as the first backlight BLR. A first wavelength of the first backlight BLR corresponds to, for example, red, and may be within a range from 600 nm to 640 nm, more preferably within a range from 610 nm to 630 nm.

Similarly, the second light source 10G includes a second transmissive OLED element that emits the second backlight BLG as the second-color light. A second transparent substrate 101G, a second transparent anode 102G, a second hole transport layer 103G, a second light-emitting layer 104G, a second electron transport layer 105G, a second transparent cathode 106G, and a second sealing layer 107G provided in the second transmissive OLED element are stacked in this order in the −Z direction in the orthogonal coordinate system.

When an appropriate voltage is applied between the second transparent anode 102G and the second transparent cathode 106G, the second transmissive OLED element emits the second-color light from the second light-emitting layer 104G as the second backlight BLG. A second wavelength of the second backlight BLG corresponds to, for example, green, and may be within a range from 500 nm to 550 nm, more preferably within a range from 520 nm to 540 nm.

Further, the third light source 10B includes a third transmissive OLED element that emits the third backlight BLB as the third-color light. A third transparent substrate 101B, a third transparent anode 102B, a third hole transport layer 103B, a third light-emitting layer 104B, a third electron transport layer 105B, a third transparent cathode 106B, and a third sealing layer 107B provided in the third transmissive OLED element are stacked in this order in the −Z direction in the orthogonal coordinate system.

When an appropriate voltage is applied between the third transparent anode 102B and the third transparent cathode 106B, the third transmissive OLED element emits the third-color light from the third light-emitting layer 104B as the third backlight BLB. A third wavelength of the third backlight BLB corresponds to, for example, blue, and may be within the range from 450 nm to 480 nm, more preferably within a range from 450 nm to 460 nm.

In the example in FIG. 8, the first light source 10R, the second light source 10G, and the third light source 10B simultaneously emit the first backlight BLR, the second backlight BLG, and the third backlight BLB, respectively, under the control of the control device 80, so that the light emission region 10A of the light source member 10 emits the white backlight BL.

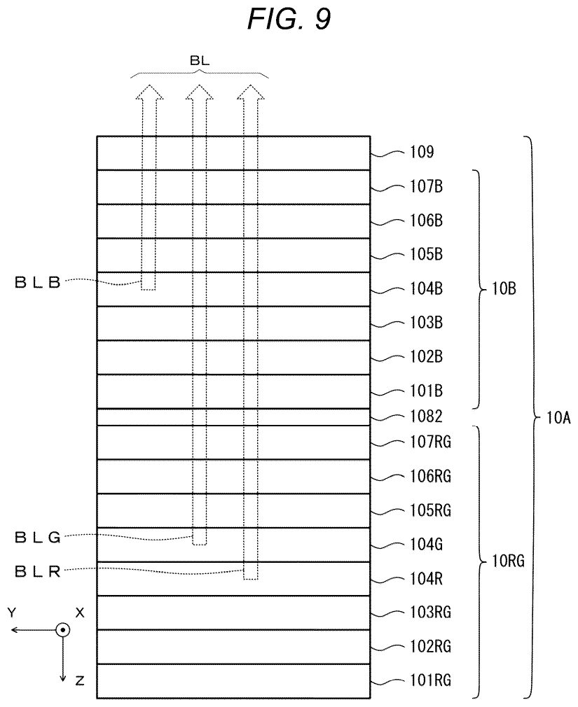

As another example, as shown in FIG. 9, the light emission region 10A of the light source member 10 may be provided with a fourth light source 10RG in which the first light source 10R and the second light source 10G in FIG. 8 are integrated. The cross-sectional view in FIG. 9 is obtained by adding the following modifications to the cross-sectional view in FIG. 8. That is, the first light source 10R and the first adhesive layer 1081 are removed, and the second light source 10G is replaced with the fourth light source 10RG. A fourth transparent substrate 101RG, a fourth transparent anode 102RG, a fourth hole transport layer 103RG, the first light-emitting layer 104R, the second light-emitting layer 104G, a fourth electron transport layer 105RG, a fourth transparent cathode 106RG, and a fourth sealing layer 107RG provided in the fourth light source 10RG are stacked in this order in the −Z direction in the orthogonal coordinate system.

In the fourth light source 10RG, when an appropriate voltage is applied between the fourth transparent anode 102RG and the fourth transparent cathode 106RG, the first light-emitting layer 104R emits the first-color backlight BLR, and the second light-emitting layer 104G emits the second-color backlight BLG.

The other configurations and operations of the light source member 10 are the same as those of the third embodiment shown in FIG. 8. According to the present modification example, the size of the light source member 10 can be further reduced as compared with the configuration in FIG. 8.

### Modification Example of Patterned Half-Waveplate

As described above with reference to FIG. 3, the video lights ML emitted from the sub-pixels PXs (R), PXs (G), and PXs (B) of the transmissive liquid crystal panel 22 are linearly-polarized lights in the first polarization direction by the first polarization region 23A of the patterned half-waveplate 23. The external light OL transmitted through the transparent region PXs (T) of the transmissive liquid crystal panel 22 becomes the linearly-polarized light in the second polarization direction orthogonal to the first polarization direction by the second polarization region 23T of the patterned half-waveplate 23. Here, as an example, in the patterned half-waveplate 23, the first polarization region 23A may have a first polarization characteristic selectively functioning with respect to a linearly-polarized light in a polarization direction parallel to the first axis direction contained in the XY plane, and the second polarization region 23T may have a second polarization characteristic selectively functioning with respect to a linearly-polarized light in a polarization direction orthogonal to the first axis direction contained in the XY plane. Further, as another example, in the patterned half-waveplate 23, the first polarization region 23A may have a polarization characteristic of selectively functioning with respect to a linearly-polarized light in a polarization direction parallel to the first axis direction contained in the XY plane, and the second polarization region 23T may transmit the external light OL without changing the polarization state.

### Modification Example of Positional Relationship of Transmissive Liquid Crystal Panel

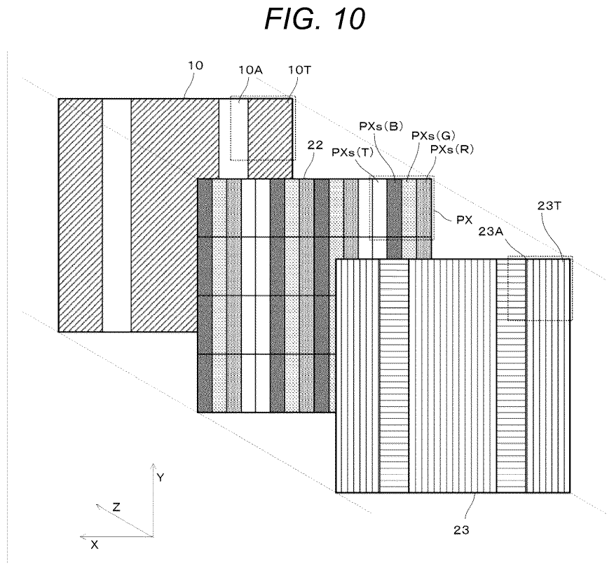

In the configuration example illustrated in FIG. 3, the case where the arrangement of the sub-pixels PXs (R), PXs (G), and PXs (B) and the transparent region PXs (T) provided in each of the plurality of pixels PX of the transmissive liquid crystal panel 22 is the same in all the pixels PX is described. As a modification example of this configuration, as illustrated in FIG. 10, the sub-pixels PXs (R), PXs (G), and PXs (B) and the transparent regions PXs (T) may be arranged such that the transparent regions PXs (T) of two pixels PX adjacent to each other in the first arrangement direction are adjacent to each other in the first arrangement direction. In this modification example, since the two transparent regions PXs (T) adjacent to each other in the first arrangement direction can be integrated, the manufacturing accuracy of the transparent regions PXs (T) is advantageous.

In the configuration example in FIG. 10, as compared with the configuration example in FIG. 3, the arrangement of the light emission region 10A and the transparent region 10T in the light source member 10 is changed according to the arrangement of the sub-pixels PXs (R), PXs (G), and PXs (B) and the transparent region PXs (T) in the transmissive liquid crystal panel 22. That is, the light emission region 10A is disposed at a position facing the sub-pixels PXs (R), PXs (G), and PXs (B), and the transparent region 10T is disposed at a position facing the transparent region PXs (T). As a result, in the light source member 10, the light emission regions 10A adjacent to each other in the first arrangement direction can be integrated, and the transparent regions PXs (T) adjacent to each other in the first arrangement direction can be integrated, which is advantageous in manufacturing accuracy of the light emission regions 10A and the transparent regions 10T.

Similarly, in the configuration example in FIG. 10, as compared with the configuration example in FIG. 3, the arrangement of the first polarization region 23A and the second polarization region 23T in the patterned half-waveplate 23 is changed according to the arrangement of the sub-pixels PXs (R), PXs (G), and PXs (B) and the transparent region PXs (T) in the transmissive liquid crystal panel 22. That is, the first polarization region 23A is disposed at a position facing the sub-pixels PXs (R), PXs (G), and PXs (B), and the second polarization region 23T is disposed at a position facing the transparent region PXs (T). As a result, since the first polarization regions 23A adjacent to each other in the first arrangement direction in the patterned half-waveplate 23 can be integrated, the second polarization regions 23T adjacent to each other in the first arrangement direction can be integrated, which is advantageous in manufacturing accuracy of the first polarization regions 23A and the second polarization regions 23T.

The virtual image display device 100A, 100B or the optical unit 100 according to the first embodiment described above includes the segmented OLED panel as the light source member 10 having the light emission region 10A that emits the backlight BL and the first transparent region 10T that transmits the external light OL, the display element 20 having the pixel PX including the sub-pixels PXs (R), PXs (G), and PXs (B) facing the light emission region 10A and transmitting the backlight BL and emitting the video light ML and the second transparent region PXs (T) facing the first transparent region 10T and transmitting the external light OL, the patterned half-waveplate 23 having the first polarization region 23A facing the sub-pixels PXs (R), PXs (G), and PXs (B) and having the first polarization characteristic selectively functioning with respect to the linearly-polarized light in the polarization direction parallel to the first axis direction and the second polarization region 23T facing the second transparent region PXs (T) and having the polarization characteristic different from that of the first polarization region 23A, and the polarization imaging optical system 50 facing the display element 20 with the patterned half-waveplate 23 in between, imaging the video light ML, and transmitting at least a part of the external light OL.

In the virtual image display device 100A, 100B or the optical unit 100 described above, the light source member 10 and the polarization imaging optical system 50 can be downsized and both high transmittance for the external light OL and good display of the video light ML can be achieved. Further, in the virtual image display device 100A, 100B or the optical unit 100, by using the polarization imaging optical system 50 including the polarization liquid crystal lens 51 that images the video light ML having the first linearly-polarized light P1 with positive power and transmits the external light OL having the second linearly-polarized light P2, the video light ML and the external light OL can be simultaneously guided to the eye EY without performing time-sharing control that may cause a decrease in visibility.

### Second Embodiment

Hereinafter, virtual image display devices 100A, 100B, and the like according to a second embodiment will be described. The virtual image display devices 100A and 100B according to the second embodiment are obtained by partially changing the virtual image display devices 100A and 100B according to the first embodiment, and the description of portions common to the virtual image display devices 100A and 100B according to the first exemplary embodiment will be omitted.

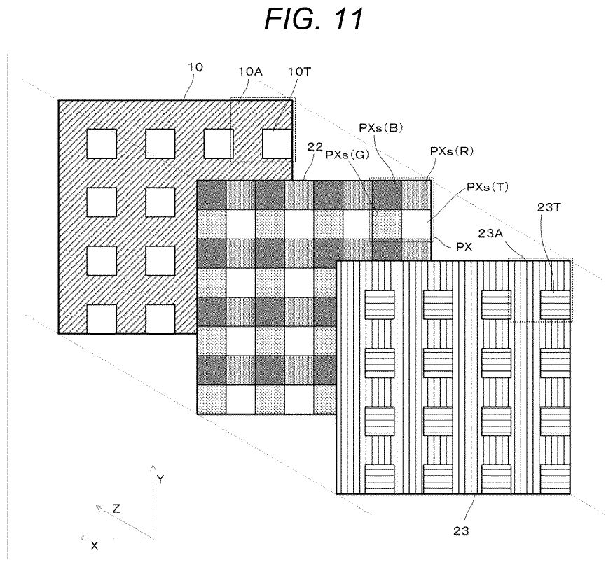

As illustrated in FIG. 11, the sub-pixels PXs (R), PXs (G), and PXs (B) and the transparent region PXs (T) provided in each of the pixels PX of the transmissive liquid crystal panel 22 according to the present embodiment are arranged in a matrix, two in the first arrangement direction and two in the second arrangement direction. As an example, in each pixel PX, the first-color sub-pixel PXs (R) and the third-color sub-pixel PXs (B) are adjacent to each other in the first arrangement direction, and the second-color sub-pixel PXs (G) and the transparent region PXs (T) are adjacent to each other in the first arrangement direction. In each pixel PX, the first-color sub-pixel PXs (R) and the second-color sub-pixel PXs (G) are adjacent to each other in the second arrangement direction, and the third-color sub-pixel PXs (B) and the transparent region PXs (T) are adjacent to each other in the second arrangement direction. However, these positional relationships are merely examples, and do not limit the present embodiment.

In the present embodiment, as illustrated in FIG. 11, the shapes and arrangements of the light emission region 10A and the transparent region 10T in the light source member 10 are obtained by adding the following modifications to the configuration example in FIG. 3. That is, in the light source member 10, the light emission region 10A is disposed in a shape facing the sub-pixels PXs (R), PXs (G), and PXs (B) provided in each pixel PX of the transmissive liquid crystal panel 22, and the transparent region 10T is disposed in a shape facing the transparent region PXs (T) provided in each pixel PX of the transmissive liquid crystal panel 22.

Similarly, in the present embodiment, as illustrated in FIG. 11, the shapes and arrangements of the first polarization region 23A and the second polarization region 23T in the patterned half-waveplate 23 are obtained by adding the following changes to the configuration example in FIG. 3. That is, in the patterned half-waveplate 23, the first polarization region 23A is disposed in a shape facing the sub-pixels PXs (R), PXs (G), and PXs (B) provided in each pixel PX of the transmissive liquid crystal panel 22, and the second polarization region 23T is disposed in a shape facing the transparent region PXs (T) provided in each pixel PX of the transmissive liquid crystal panel 22.

Also, in the configuration according to the present embodiment illustrated in FIG. 11, similarly to the case of the first embodiment, the light source member 10 and the polarization imaging optical system 50 can be downsized and both high transmittance for the external light OL and good display of the video light ML can be achieved. Further, the video light ML and the external light OL can be simultaneously guided to the eye EY without performing time-sharing control that may cause a decrease in visibility.

### Modification Example of Positional Relationship of Transmissive Liquid Crystal Panel

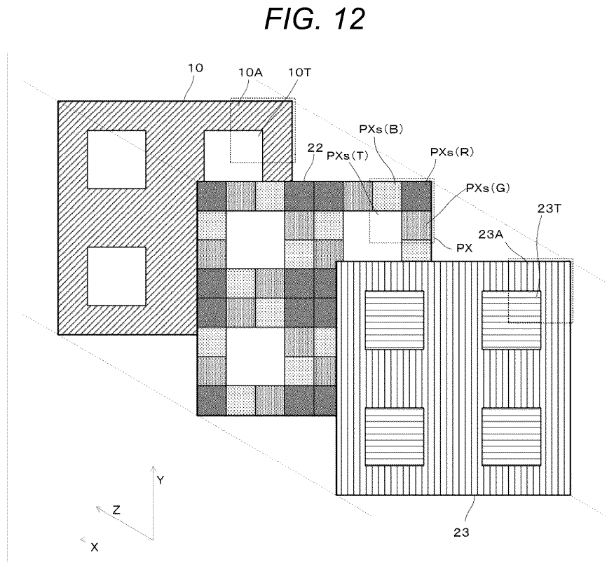

In the configuration example illustrated in FIG. 11, the case where the arrangement of the sub-pixels PXs (R), PXs (G), and PXs (B) and the transparent region PXs (T) provided in each of the plurality of pixels PX of the transmissive liquid crystal panel 22 is the same in all the pixels PX is described. As a modification example of this configuration, as illustrated in FIG. 12, the sub-pixels PXs (R), PXs (G), and PXs (B) and the transparent regions PXs (T) may be arranged such that the transparent regions PXs (T) of four pixels PX adjacent in the first arrangement direction and the second arrangement direction in a matrix form are adjacent in the first arrangement direction or the second arrangement direction. As an example, the transparent region PXs (T) provided in a first pixel PX and the transparent region PXs (T) provided in a second pixel PX adjacent to the first pixel PX in the first arrangement direction are adjacent to each other in the first arrangement direction, the transparent region PXs (T) provided in the first pixel PX and the transparent region PXs (T) provided in a third pixel PX adjacent to the first pixel PX in the second arrangement direction are adjacent to each other in the second arrangement direction, the transparent region PXs (T) provided in the third pixel PX and the transparent region PXs (T) provided in a fourth pixel PX adjacent to the third pixel PX in the first arrangement direction and adjacent to the second pixel PX in the second arrangement direction are adjacent to each other in the first arrangement direction, and the transparent region PXs (T) provided in the second pixel PX and the transparent region PXs (T) provided in the fourth pixel PX are adjacent to each other in the second arrangement direction. As shown in FIG. 12, since the four transparent regions PXs (T) provided in the first pixel PX, the second pixel PX, the third pixel PX, and the fourth pixel PX can be integrated, the manufacturing accuracy of the transparent region PXs (T) is advantageous.

### Third Embodiment

Hereinafter, virtual image display devices 100A, 100B, and the like according to a third embodiment will be described. The virtual image display devices 100A and 100B according to the third embodiment are obtained by partially changing the virtual image display devices 100A and 100B according to the first embodiment, and the description of portions common to the virtual image display devices 100A and 100B according to the first exemplary embodiment will be omitted.

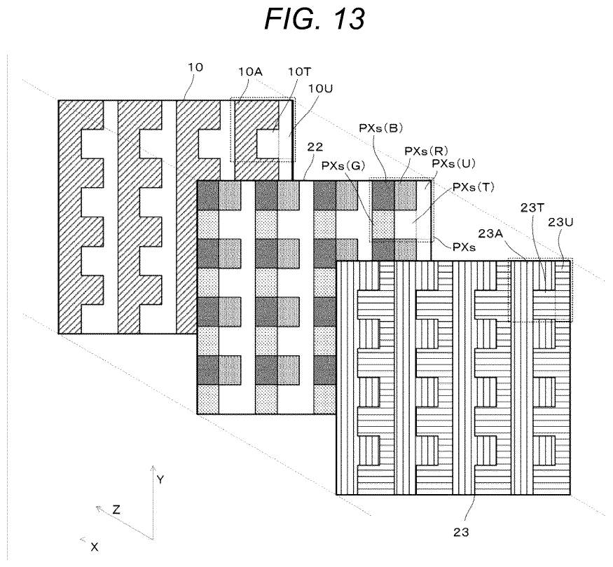

As illustrated in FIG. 13, the sub-pixels PXs (R), PXs (G), and PXs (B) and the transparent region PXs (T) provided in each pixel PX of the transmissive liquid crystal panel 22 according to the present embodiment have a configuration obtained by combining the first embodiment illustrated in FIG. 3 and the second embodiment illustrated in FIG. 11. That is, each pixel PX includes sub-pixels PXs (R), PXs (G), and PXs (B) and a first transparent region PXs (T) adjacent to each other in the first arrangement direction and the second arrangement direction, and a second transparent region PXs (U) adjacent to the first transparent region PXs (T) in the first arrangement direction. Here, the sub-pixels PXs (R), PXs (G), and PXs (B) and the first transparent region PXs (T) according to the present embodiment illustrated in FIG. 13 are reduced in width in the first arrangement direction by the second transparent region PXs (U) as compared with the sub-pixels PXs (R), PXs (G), and PXs (B) and the first transparent region PXs (T) according to the second embodiment illustrated in FIG. 11. Similarly to the first transparent region PXs (T), the second transparent region PXs (U) transmits the external light OL. The first transparent region PXs (T) and the second transparent region PXs (U) may be adjacent to each other in the first arrangement direction or may be integrated with each other.

In the present embodiment, the light source member 10 is obtained by adding the following modifications to the configuration example in FIG. 11. That is, the light emission region 10A of the light source member 10 is disposed in a shape facing the sub-pixels PXs (R), PXs (G), and PXs (B) of the transmissive liquid crystal panel 22, the transparent region 10T of the light source member 10 is disposed in a shape facing the first transparent region PXs (T) of the transmissive liquid crystal panel 22 as the first transparent region 10T, and a second transparent region 10U disposed in a shape facing the second transparent region PXs (U) of the transmissive liquid crystal panel 22 is added. Similarly to the first transparent region 10T, the second transparent region 10U transmits the external light OL. The first transparent region 10T and the second transparent region 10U may be adjacent to each other in the first arrangement direction or may be integrated with each other.

Similarly, in the present embodiment, the patterned half-waveplate 23 is obtained by adding the following changes to the configuration example in FIG. 11. That is, the first polarization region 23A of the patterned half-waveplate 23 is disposed in a shape facing the sub-pixels PXs (R), PXs (G), and PXs (B) of the transmissive liquid crystal panel 22, the second polarization region 23T of the patterned half-waveplate 23 is disposed in a shape facing the first transparent region PXs (T) of the transmissive liquid crystal panel 22, and a third polarization region 23U disposed in a shape facing the second transparent region PXs (U) of the transmissive liquid crystal panel 22 is added. Similar to the second polarization region 23T, the third polarization region 23U changes the polarization state of the external light OL to the second linearly-polarized light P2. The second polarization region 23T and the third polarization region 23U may be integrated.

Also, in the configuration according to the present embodiment illustrated in FIG. 13, similarly to the cases of the first embodiment and the second embodiment, the light source member 10 and the polarization imaging optical system 50 can be downsized and both high transmittance for the external light OL and good display of the video light ML can be achieved. Further, the video light ML and the external light OL can be simultaneously guided to the eye EY without performing time-sharing control that may cause a decrease in visibility. Further, as compared with the second embodiment, in the transmissive liquid crystal panel 22, the ratio of the area through which the external light OL is transmitted to the area through which the video light ML is emitted can be increased with a higher degree of freedom.

A virtual image display device in a specific configuration includes a segmented OLED (organic light emitting diode) panel having a light emission region that emits a backlight and a first transparent region that transmits an external light, a display element having a pixel including a sub-pixel that faces the light emission region and transmits the backlight to emit a video light and a second transparent region that faces the first transparent region and transmits the external light, a patterned half-waveplate having a first polarization region that faces the sub-pixel and has a first polarization characteristic selectively functioning with respect to a linearly-polarized light in a polarization direction parallel to a first axis direction and a second polarization region that faces the second transparent region and has a polarization characteristic different from that of the first polarization region, and a polarization imaging optical system that faces the display element with the patterned half-waveplate in between, images the video light from the patterned half-waveplate, and transmits the external light from the patterned half-waveplate.

In the virtual image display device in a specific configuration, the polarization imaging optical system performs a different action of functioning as a lens or transmitting an incident light depending a on polarization state of the incident light.

In the virtual image display device in the specific configuration, the polarization imaging optical system includes a polarization liquid crystal lens that has positive power with respect to the video light having a first linearly-polarized light in a first polarization direction and transmits the external light having a second linearly-polarized light in a second polarization direction orthogonal to the first polarization direction, and the patterned half-waveplate converts the video light from the sub-pixel into the first linearly-polarized light by the first polarization region and emits the first linearly-polarized light, and converts the external light from the second transparent region into the second linearly-polarized light by the second polarization region and emits the second linearly-polarized light.

In the virtual image display device in the specific configuration, the second polarization region has a second polarization characteristic selectively functioning with respect to a linearly-polarized light orthogonal to the first axis direction.

In the virtual image display device in the specific configuration, the second polarization region transmits the external light.

In the virtual image display device described above, the light source member 10 and the polarization imaging optical system 50 can be downsized and both high transmittance for the external light OL and good display of the video light ML can be achieved. Further, in the virtual image display device 100A, 100B or the optical unit 100, by using the polarization imaging optical system 50 including the polarization liquid crystal lens 51 that images the video light ML having the first linearly-polarized light with positive power and transmits the external light OL having the second linearly-polarized light, the video light ML and the external light OL can be simultaneously guided to the eye EY without performing time-sharing control that may cause a decrease in visibility.

In the virtual image display device in the specific configuration, the display element includes a transmissive liquid crystal panel including a plurality of the pixels arranged in a matrix, and
each of the plurality of pixels includes:
a first sub-pixel that faces the light emission region and displays a first video representing an intensity distribution of a wavelength component of a first color in videos of the video light;
a second sub-pixel that faces the light emission region and displays a second video representing an intensity distribution of a wavelength component of a second color in the videos of the video light;
a third sub-pixel that faces the light emission region and displays a third video representing an intensity distribution of a wavelength component of a third color in the videos of the video light; and
the second transparent region that faces the first transparent region and transmits the external light.

In the virtual image display device in the specific configuration, the first sub-pixel includes a first color filter that selectively transmits a light of the first color, the second sub-pixel includes a second color filter that selectively transmits a light of the second color, and the third sub-pixel includes a third color filter that selectively transmits a light of the third color.

In the virtual image display device described above, one transmissive liquid crystal panel including color filters of three colors as display elements can be adopted.

In the virtual image display device in the specific configuration, in each of the plurality of pixels, the first sub-pixel, the second sub-pixel, the third sub-pixel, and the second transparent region are arranged side by side in a first arrangement direction, and in a first pixel and a second pixel adjacent to the first pixel in a second arrangement direction orthogonal to the first arrangement direction among the plurality of pixels, the first sub-pixel, the second sub-pixel, the third sub-pixel, and the second transparent region of the first pixel are adjacent to the first sub-pixel, the second sub-pixel, the third sub-pixel, and the second transparent region of the second pixel in the second arrangement direction, respectively.

In the virtual image display device described above, since the sub-pixels of each color and the second transparent region extend in the second arrangement direction, manufacturing accuracy is advantageous.

In the virtual image display device in the specific configuration, in the first pixel and a third pixel adjacent to the first pixel in the first arrangement direction among the plurality of pixels, the second transparent region of the first pixel and the second transparent region of the third pixel are adjacent to each other in the first arrangement direction.

In the virtual image display device described above, since the width of the second transparent region in the first arrangement is relatively large, manufacturing accuracy is advantageous.

In the virtual image display device in the specific configuration, in each of the plurality of pixels, the first sub-pixel and the second sub-pixel are adjacent to each other in one arrangement direction of a first arrangement direction and a second arrangement direction orthogonal to the first arrangement direction, the third sub-pixel and the second transparent region are adjacent to each other in the one arrangement direction, the first sub-pixel and the third sub-pixel are adjacent to each other in the other arrangement direction of the first arrangement direction and the second arrangement direction, and the second sub-pixel and the second transparent region are adjacent to each other in the other arrangement direction.

In the virtual image display device described above, since the minimum dimension of the sub-pixel is relatively large, manufacturing accuracy is advantageous.

In the virtual image display device in the specific configuration, in a first pixel, a second pixel adjacent to the first pixel in the first arrangement direction, a third pixel adjacent to the first pixel in the second arrangement direction, and a fourth pixel adjacent to the second pixel in the second arrangement direction and adjacent to the third pixel in the first arrangement direction among the plurality of pixels, the second transparent region of the first pixel is adjacent to the second transparent region of the second pixel in the first arrangement direction, the second transparent region of the first pixel is adjacent to the second transparent region of the third pixel in the second arrangement direction, the second transparent region of the second pixel is adjacent to the second transparent region of the fourth pixel in the second arrangement direction, and the second transparent region of the third pixel is adjacent to the second transparent region of the fourth pixel in the first arrangement direction.

In the virtual image display device described above, since the minimum dimension of the second transparent region is relatively large, manufacturing accuracy is advantageous.

In the virtual image display device in the specific configuration, each of the plurality of pixels further includes a third transparent region that is adjacent to the second transparent region and transmits the external light, the segmented OLED panel further includes a fourth transparent region that faces the third transparent region and transmits the external light, and the patterned half-waveplate further includes a fifth transparent region that faces the third transparent region and transmits the external light.

In the virtual image display device in the specific configuration, in each of the plurality of pixels, the second transparent region and the third transparent region are adjacent to each other in one arrangement direction of the first arrangement direction and the second arrangement direction, and in a first pixel and a second pixel adjacent to the first pixel in the other arrangement direction of the first arrangement direction and the second arrangement direction, the third transparent region of the first pixel and the third transparent region of the second pixel are adjacent to each other in the other arrangement direction.

In the virtual image display device described above, in the transmissive liquid crystal panel, the ratio of the area through which the external light is transmitted to the area through which the video light is emitted can be increased with a higher degree of freedom.

An optical unit in a specific configuration includes a segmented OLED (organic light emitting diode) panel having a light emission region that emits a backlight and a first transparent region that transmits an external light, a display element having a pixel including a sub-pixel that faces the light emission region and transmits the backlight to emit a video light and a second transparent region that faces the first transparent region and transmits the external light, a patterned half-waveplate having a first polarization region that faces the sub-pixel and has a first polarization characteristic selectively functioning with respect to a linearly-polarized light in a polarization direction parallel to a first axis direction and a second polarization region that faces the second transparent region and has a polarization characteristic different from that of the first polarization region, and a polarization imaging optical system that faces the display element with the patterned half-waveplate in between, images the video light from the patterned half-waveplate, and transmits the external light from the patterned half-waveplate.

In the optical unit described above, the light source member 10 and the polarization imaging optical system 50 can be downsized and both high transmittance for the external light OL and good display of the video light ML can be achieved. Further, in the virtual image display device 100A, 100B or the optical unit 100, by using the polarization imaging optical system 50 including the polarization liquid crystal lens 51 that images the video light ML having the first linearly-polarized light with positive power and transmits the external light OL having the second linearly-polarized light, the video light ML and the external light OL can be simultaneously guided to the eye EY without performing time-sharing control that may cause a decrease in visibility.

What is claimed is:

1. A virtual image display device, comprising:
a segmented organic light emitting diode panel having a light emission region that is configured to emit a backlight and a first transparent region that is configured to transmit an external light;
a display element having a pixel including a sub-pixel that faces the light emission region and is configured to transmit the backlight to emit a video light and a second transparent region that faces the first transparent region and is configured to transmit the external light;
a patterned half-waveplate having a first polarization region that faces the sub-pixel and has a first polarization characteristic selectively functioning with respect to a linearly-polarized light in a polarization n direction parallel to a first axis direction and a second polarization region that faces the second transparent region and has a polarization characteristic different from that of the first polarization region; and
a polarization imaging optical system that faces the display element with the patterned half-waveplate in between, is configured to image the video light from the patterned half-waveplate, and is configured to transmit the external light from the patterned half-waveplate.

2. The virtual image display device according to claim 1, wherein
the polarization imaging optical system is configured to performs different action of functioning as a lens or transmitting an incident light depending on a polarization state of the incident light.

3. The virtual image display device according to claim 1, wherein
the polarization imaging optical system includes a polarization liquid crystal lens that has positive power with respect to the video light having a first linearly-polarized light in a first polarization direction and is configured to transmit the external light having a second linearly-polarized light in a second polarization direction orthogonal to the first polarization direction, and
the patterned half-waveplate is configured to convert the video light from the sub-pixel into the first linearly-polarized light by the first polarization region and emit the first linearly-polarized light, and is configured to convert the external light from the second transparent region into the second linearly-polarized light by the second polarization region and emit the second linearly-polarized light.

4. The virtual image display device according to claim 1, wherein
the second polarization region has a second polarization characteristic selectively functioning with respect to a linearly-polarized light orthogonal to the first axis direction.

5. The virtual image display device according to claim 1, wherein
the second polarization region is configured to transmit the external light.

6. The virtual image display device according to claim 1, wherein
the display element includes a transmissive liquid crystal panel including a plurality of the pixels arranged in a matrix, and
each of the plurality of pixels includes:
a first sub-pixel that faces the light emission region and is configured to display a first video representing an intensity distribution of a wavelength component of a first color in videos of the video light;
a second sub-pixel that faces the light emission region and is configured to display a d video representing an intensity distribution of a wavelength component of a second color in the videos of the video light;
a third sub-pixel that faces the light emission region and is configured to display a third video representing an intensity distribution of a wavelength component of a third color in the videos of the video light; and
the second transparent region that faces the first transparent region and is configured to transmit the external light.

7. The virtual image display device according to claim 6, wherein
the first sub-pixel includes a first color filter that is configured to selectively transmit a light of the first color,
the second sub-pixel includes a second color filter that is configured to selectively transmit a light of the second color, and
the third sub-pixel includes a third color filter that is configured to selectively transmit a light of the third color.

8. The virtual image display device according to claim 6, wherein
in each of the plurality of pixels, the first sub-pixel, the second sub-pixel, the third sub-pixel, and the second transparent region are arranged side by side in a first arrangement direction, and
in a first pixel and a second pixel adjacent to the first pixel in a second arrangement direction orthogonal to the first arrangement direction among the plurality of pixels, the first sub-pixel, the second sub-pixel, the third sub-pixel, and the second transparent region of the first pixel are adjacent to the first sub-pixel, the second sub-pixel, the third sub-pixel, and the second transparent region of the second pixel in the second arrangement direction, respectively.

9. The virtual image display device according to claim 8, wherein
in the first pixel and a third pixel adjacent to the first pixel in the first arrangement direction among the plurality of pixels, the second transparent region of the first pixel and the second transparent region of the third pixel are adjacent to each other in the first arrangement direction.

10. The virtual image display device according to claim 6, wherein
in each of the plurality of pixels, the first sub-pixel and the second sub-pixel are adjacent to each other in one arrangement direction of a first arrangement direction and a second arrangement direction orthogonal to the first arrangement direction, the third sub-pixel and the second transparent region are adjacent to each other in the one arrangement direction, the first sub-pixel and the third sub-pixel are adjacent to each other in the other arrangement direction of the first arrangement direction and the second arrangement direction, and the second sub-pixel and the second transparent region are adjacent to each other in the other arrangement direction.

11. The virtual image display device according to claim 10, wherein
in a first pixel, a second pixel adjacent to the first pixel in the first arrangement direction, a third pixel adjacent to the first pixel in the second arrangement direction, and a fourth pixel adjacent to the second pixel in the second arrangement direction and adjacent to the third pixel in the first arrangement direction among the plurality of pixels, the second transparent region of the first pixel is adjacent to the second transparent region of the second pixel in the first arrangement direction, the second transparent region of the first pixel is adjacent to the second transparent region of the third pixel in the second arrangement direction, the second transparent region of the second pixel is adjacent to the second transparent region of the fourth pixel in the second arrangement direction, and the second transparent region of the third pixel is adjacent to the second transparent region of the fourth pixel in the first arrangement direction.

12. The virtual image display device according to claim 10, wherein
each of the plurality of pixels further includes a third transparent region that is adjacent to the second transparent region and is configured to transmit the external light,
the segmented organic light emitting diode panel further includes a fourth transparent region that faces the third transparent region and is configured to transmit the external light, and
the patterned half-waveplate further includes a fifth transparent region that faces the third transparent region and is configured to transmit the external light.

13. The virtual image display device according to claim 12, wherein
in each of the plurality of pixels, the second transparent region and the third transparent region are adjacent to each other in one arrangement direction of the first arrangement direction and the second arrangement direction, and
in a first pixel and a second pixel adjacent to the first pixel in the other arrangement direction of the first arrangement direction and the second arrangement direction, the third transparent region of the first pixel and the third transparent region of the second pixel are adjacent to each other in the other arrangement direction.

14. An optical unit comprising:
a segmented organic light emitting diode panel having a light emission region that is configured to emit a backlight and a first transparent region that is configured to transmit an external light;
a display element having a pixel including a sub-pixel that faces the light emission region and is configured to transmit the backlight to emit a video light and a second transparent region that faces the first transparent region and is configured to transmit the external light;
a patterned half-waveplate having a first polarization region that faces the sub-pixel and has a first polarization characteristic selectively functioning with respect to a linearly-polarized light in a polarization direction parallel to a first axis direction and a second polarization region that faces the second transparent region and has a polarization characteristic different from that of the first polarization region; and
a polarization imaging optical system that faces the display element with the patterned half-waveplate in between, is configured to image the video light from the patterned half-waveplate, and is configured to transmit the external light from the patterned half-waveplate.
